(19) United States
(12) Patent Application Publication
(10) Pub. No.: US 2005/0071058 A1
(43) Pub. Date: Mar. 31, 2005

(54) Interactive system for live streaming of data using wireless internet services

(76) Inventor: James Salande JR., Slidell, LA (US)

Correspondence Address: THOMAS S. KEATY;KEATY PROFESSIONAL LAW CORP., 2140 WORLD TRADE CENTER, NO. 2 CANAL STREET, NEW ORLEANS, LA, 70130, US

(21) Appl. No.: 10/649,157

(22) Filed: Aug. 27, 2003

(51) Int. Cl. G06F 7/00

(52) U.S. Cl. 701/35; 701/200; 701/200

(57) ABSTRACT

An interactive system for live streaming of data to and from a moving vehicle uses GPS system and cellular communications for transmitting data collected by a plurality of video cameras positioned inside and outside on a traveling vehicle. The main CPU collects, stores and processes the data from the cameras and transmits the data to an authorized remote CPU, which may be a home-based computer or a security monitoring station. The main CPU allows networked communications via the Internet to the occupants of the vehicle and may be accessed by authorized personnel via the Internet.

### BACKGROUND OF THE INVENTION

The present invention relates to an interactive transmitter/receiver system particularly adapted for use in mobile environments, such as in land, air and water vehicles. Even more particularly, the present invention relates to an interactive system of receiving and transmitting data using communications database of wireless internet services.

The issue of security has reached an unprecedented high due to a continuous terrorism threat both in this country and abroad. Companies are concerned with safety of their personnel and property, families are concerned with the safety of their traveling family members, the governments are concerned with the safety of citizens, military, aircraft, trains, etc. The heightened security levels demand ever-increasing expenditures for monitoring the conditions of traveling vehicles, where conventional stationary monitoring systems are ineffective.

Many cities around the world initiated video monitoring of public access areas, streets, shopping malls, elevators, and the like. The real time monitoring allows operators at their central control location a real time observation of potentially illegal activities taking place in a particular location. Should an illegal activity be detected, a police unit may be dispatched to the site or alert other security systems of the potentially dangerous activity. However, the video monitoring of public places is ineffective when illegal attempts are made against personnel or property located in motor vehicle.

There have been attempts to solve the safety issue by positioning video cameras in the moving vehicles and transmitting the video live images through the Internet. However, the known devices have either inadequate number of cameras, for instance one camera positioned at the front of the vehicle that does not cover the entire field of concern or, when multiple video cameras are installed, the unit becomes too bulky. The multiple camera data transmission via Internet uses too much power to operate and tends to overheat. Also, the known units are too large for placing in an average size automobile.

The present invention contemplates elimination of drawbacks associated with the prior art and provision of a compact interactive mobile data transmitter/receiver system that uses the Internet connection for transmittal of real time images to a remote authorized center.

### SUMMARY OF THE INVENTION

It is, therefore, an object of the present invention to provide a compact interactive system for data transmission that can be mounted in an average sized automobile for capturing and transmitting real time images via the Internet.

It is another object of the present invention to provide an interactive and a portable data transmitter/receiver system that allows live streaming of data using global positioning system.

These and other objects of the present invention are achieved through a provision of an interactive system for live streaming of data to and from a moving vehicle. The system is powered by a standard 12-volt DC power, such as the vehicle battery. The system comprises a plurality of data collection devices, such as digital video cameras disposed inside and/or outside on the vehicle. A main control processing unit (CPU) is operationally connected to the plurality of the video cameras for receiving, storing and processing the data received from the cameras.

The main CPU is configured for networked communications with a remote second control processing unit (CPU), which may be a home computer, a PDA device, desktop computer at a monitoring location, police station, etc. The system utilizes a location identifying communication database, such as GPS system and wireless communications to live stream the data processed by the main CPU via the Internet to the authorized remote second CPU. The data may be protected against unauthorized access by password, encryption and other similar means.

The use of a mini-ITX system and associated motherboard allows to reduce the space occupied by the system components located in the vehicle. The system of the present invention generates less heat than is associated with other monitoring systems designed for use in vehicles, such as automobiles. The main CPU is configured to allow network access through the Internet to various databases, permits receiving and sending of e-mail, playing of music, movies, video games and other tasks conventionally associated with computers.

### BRIEF DESCRIPTION OF THE DRAWINGS

Reference will now be made to the drawings, wherein like parts are designated by like numerals and wherein FIG. 1 is a simplified schematic diagram of real time communication system of the present invention.

FIG. 2 is a simplified schematic diagram of real time communications between the main CPU and a second remote CPU via networked connection.

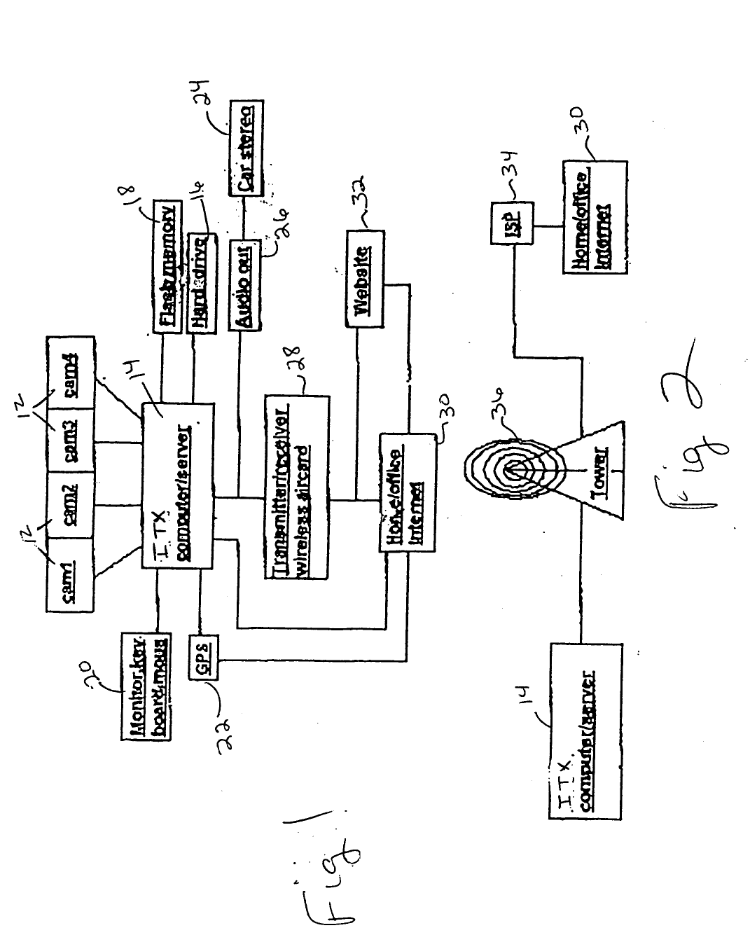

### DETAILED DESCRIPTION OF THE PREFERRED EMBODIMENT

Now referring to FIG. 1, a simplified diagram of the communications connection of the real time communications system in accordance with the present invention is shown. The system of the present invention, designated generally by numeral 10 comprises one or more video cameras 12 positioned in a desired location, for instance interior of a vehicle. The cameras 12 are powered by a standard 12-volt DC battery and use 3 volts of power. In the preferred embodiment the system uses a mini-ITX system readily available on the market. In comparison with the conventional systems powered by 120 volt AC, 250-watt system, the compact portable system of the present system generates considerably less heat in an enclosed environment, such as a car interior.

The system 10 further includes a main control processing unit (CPU) 14, which receives signals from the cameras 12. The main CPU 14 has a hard drive 16 for storing data and a flash memory device 18. If desired, a monitor, keyboard and mouse may be provided and connected to the computer server 14. The combined monitor, keyboard and mouse assembly is designed by numeral 20 in FIG. 1.

The information from the cameras 12 is fed into the computer 14 through a provided video card (not shown) and is processed by the server 14. The global positioning system 22 is plugged into the USB port of the central processing unit (CPU) 14. The CPU 14 is also connected to a car stereo 24 through an audio card 26. A transmitter/receiver wireless air card 28 allows connection of the CPU 14 to the Internet by using the global positioning system 22.

The CPU 14 allows real time processing of the video and audio images collected by the cameras 12 and transmission of the images via the Internet to a selected location, for instance, a second control processing unit, such as a home computer 30. The authorized selected location may also be a governmental or private security office or any other location, which is authorized and configured to receive signals through a network connection (Internet) from the main CPU 14. The second CPU may be provided with the capability of decoding signals transmitted by the CPU 14 through the Internet if the signals have been encrypted.

Wireless communication is accomplished using a PCMCIA modem card (not shown) that is connected to the CPU 14 through a wireless Internet connectivity. The CPU 14 transmits the encoded signal through a website 32 of the Internet service provider 34 and may be accessed by the central office 30 by decoding the messages transmitted by the CPU 14. For wireless communication, the system utilizes a cellular tower 36, which receives video streaming from the CPU 14 and transmits the data to the selected central location 30 through the use of a conventional Internet service provider 34.

The CPU 14 transmits live streams of signals, which have been received from the cameras 12. The CPU 14 is adapted to “talk” to the satellite provider network to send and receive messages through the Internet and the global positioning system unit. The web server 32 provides an interface through which an operator in the central office 30 can observe in real time the events taking place in and around the vehicle, where the cameras 12 are located. In case of an emergency, the operator may send a message to the police or other governmental agencies for an immediate action.

Real time video streaming is implemented across GPS satellite communications and towers 36 allowing at the same time to map the location of the mobile unit which simplifies the task of tracking and mapping the location of the vehicle equipped with the system 10. The CPU 14 can record the images and audio signals transmitted from the cameras 12 for future analysis or evidence if necessary. All recorded data may be stored in a plurality of databases located in the CPU 14 or at the central location 30 as desired.

The system 10 further allows the occupant of the mobile unit wherein the system 10 is located to search the Internet, listen to audio through the automobile speakers (using FM modulator), watch T.V., play computer games, movies, or music. The system 10 does not interfere with the normal use of the cellular communications, and the user may talk on the phone while the CPU is active receiving images from the cameras 12.

The system 10 allows the user to receive and send emails, files and other data for work, entertainment, or information. The cameras 12 may be located inside a moving vehicle, on the outside of the vehicle, showing front, rear, and sides of the vehicle and can record the live images on the hard drive of the CPU 14. The CPU 14 located inside the car may be accessed from any Internet-connected location and the central monitoring location 30 may be accessed from the computer 14 in the car or other vehicle.

If desired, the information collected and sent by the CPU 14 may be accessed by suitable authentication, such as by password, encryption, and other similar means. The system 10 allows authorized personnel to access encoded and decoded video streaming information using a plurality of devices from a number of locations, be it a central location 30 or another remote location. The location of the vehicle may be monitored using a personal communication device, such as a cellular telephone, radio, microwave communication systems, across the Internet at virtually any location in the world. The system 10 may be installed in automobiles, trucks, mobile homes, airplanes, trains, and other mobile units to allow live streaming of video and audio images through the Internet.

The cameras 12 may be miniature digital video cameras connected through a PCI card. Another PCI card, such as Sierra wireless aircard 555 may be used for the wireless Internet connection. Using this type of card, the user can transmit messages with a burst of up to 115 k with a minimum digital speed of 40 k, which is more efficient, allowing live streaming of video via the wireless connection.

Installation of the system is relatively simple: the builder installs the hard drive, DVD/CDRW and SD memory, then installs the PCI riser card and video card for cameras and PCMCIA card for wireless Internet connection. The GPS unit is then plugged into the USB port of the CPU 14. The monitor, keyboard and mouse are conventionally plugged in and the software installed. The system is then configured for passwords, bios settings, etc.

Many changes and modifications can be made in the design of the present invention without departing from the spirit thereof. We, therefore, pray that our rights to the present invention be limited only by the scope of the appended claims.

1. An interactive system for live streaming of data to and from a moving vehicle, comprising:
a plurality of data collection devices disposed in said vehicle;
a main control processing unit disposed in said vehicle and operationally connected to said plurality of data collection devices for receiving and processing data collected from said plurality of data collection devices; and
a communications means for transmitting and uploading a continuous stream of said collected data in real-time from said plurality of data collection devices via the main control processing unit to a remote control location.

2. The interactive system of claim 1, wherein said plurality of data collection devices comprises a plurality of digital video cameras.

3. The interactive system of claim 1, further comprising a means for a connecting said main control processing unit to a location identifying communication database.

4. The interactive system of claim 3, wherein said location identifying communication database comprises a GPS database.

5. The interactive system of claim 1, wherein said communications means comprises cellular communications.

6. The interactive system of claim 1, wherein said communications means comprises networked communications.

7. The interactive system of claim 1, further comprising a second control processing unit mounted in the remote control location suitably configured to receive and analyze data received from the main control processing unit.

8. The interactive system of claim 7, wherein said second central processing unit is configured as an authorized control processing unit for receiving and displaying data received from the main control processing unit over a networked connection.

9. The interactive system of claim 1, further comprising a means for connecting said main control processing unit to an audio communication device of said vehicle.

10. The interactive system of claim 6, wherein said main control processing unit is configured to receive, store and display data retrieved through the networked communications upon demand from an occupant of the vehicle.

11. The interactive system of claim 1, wherein said system is powered by a direct current battery of said vehicle.

12. The interactive system of claim 6, wherein said main control processing unit is configured for access by authorized communication via the networked communications.

13. The interactive system of claim 1, wherein said main control processing unit comprises a mini-ITX system.

14. The interactive system of claim 1, wherein said communication means comprises a wireless air card.

15. An interactive system for live streaming of data to and from a moving vehicle, comprising:
a plurality of data collection devices disposed in said vehicle;
a main control processing unit comprising a mini-ITX system disposed in said vehicle and operationally connected to said plurality of data collection devices for receiving, storing and processing data collected from said plurality of data collection devices, said main control processing unit being configured for access by authorized communication via networked communications;
a communications means for transmitting and uploading a continuous stream of said collected data in real-time from said plurality of data collection devices via the main control processing unit to a remote control location; and
a means for a connecting said main control processing unit to a location identifying communication database.

16. The interactive system of claim 15, further comprising a second control processing unit mounted in the remote control location suitably configured to receive and analyze data received from the main control processing unit.

17. The interactive system of claim 15, wherein said plurality of data collection devices comprises a plurality of digital video cameras.

18. The interactive system of claim 15, wherein said location identifying communication database comprises a GPS database.

19. The interactive system of claim 15, wherein said communications means comprises cellular communications.
